(19) United States
(12) Patent Application Publication
(10) Pub. No.: US 2015/0163089 A1
(43) Pub. Date: Jun. 11, 2015

(54) METHOD AND APPARATUS FOR MANAGING RESOURCES OF TRANSPORT NETWORK

(71) Applicant: Electronics and Telecommunications Research Institute, Daejeon (KR)

(72) Inventors: Ki Won KIM, Daejeon (KR); Sun Me KIM, Daejeon (KR); Tae Il KIM, Daejeon (KR); Jong Hyun LEE, Daejeon (KR)

(21) Appl. No.: 14/556,390

(22) Filed: Dec. 1, 2014

(30) Foreign Application Priority Data
Dec. 6, 2013 (KR) 10-2013-0151141

(51) Int. Cl. H04L 12/24

(52) U.S. Cl. CPC H04L 41/0654

(57) ABSTRACT

Provided is a method and apparatus for managing resources of a transport network, the method including monitoring a fault occurring in a transfer path, and registering, when the fault occurs in the transfer path, a normal link of a second layer assigned to an operation path of a first layer in which the fault occurs.

### CROSS-REFERENCE TO RELATED APPLICATION

This application claims the priority benefit of Korean Patent Application No. 10-2013-0151141, filed on Dec. 6, 2013, in the Korean Intellectual Property Office, the disclosure of which is incorporated herein by reference.

### BACKGROUND

1. Field of the Invention

The present invention relates to a method and apparatus for managing resources of a transport network, and more particularly, to a method and apparatus for registering a normal link assigned to a path in which a fault occurs, as a reusable resource.

2. Description of the Related Art

A transport network may be changed into a form of an integrated transport network in which a packet transport network and a circuit transport network are integrated. The integrated transport network may effectively provide an increasing amount of traffic and various services. Also, the integrated transport network may be operated and maintained at a reduced cost.

A transport network apparatus used for the integrated transport network may flexibly assign various resources, for example, an optical, a circuit, and a packet of a transport network. The transport apparatus may be an integrated switching system in which the optical, the circuit, and the packet are integrated. The integrated switching system may accommodate all of an optical layer, a circuit layer, and a packet layer. The integrated switching system may be included in the integrated transport network to be appropriately used based on a characteristic of a service, using at least two layers.

The integrated transport network may set a traffic path using resources of a lower layer in an upper layer to transfer traffic. The integrated transport network may provide a fault recovery service for the traffic path to improve service reliability. For example, the fault recovery service may be a service of setting a preliminary path in the upper layer. When a fault occurs in the traffic path, a fault recovery operation may be performed by switching a transfer path to the preliminary path.

### SUMMARY

An aspect of the present invention provides a method and apparatus for managing resources of a transport network.

Another aspect of the present invention also provides a method and apparatus for using a reusable resource by registering a normal link of a lower layer assigned to a path of an upper layer in which a fault occurs, as the reusable resource.

According to an aspect of the present invention, there is provided a method of managing resources of a transport network, the method including monitoring a fault occurring in a plurality of links of a second layer corresponding to a lower layer of a first layer of a transfer path, changing, when a broken link in which the fault occurs is present among the plurality of links, a state of the broken link to a fault state, searching for an operation path of the first layer using the broken link, searching, when the transfer path is switched from the operation path to a preliminary path, for links assigned to the operation path, and registering a normal link indicating a remaining link among the links assigned to the operation path, aside from the broken link, as a reusable resource.

The method of managing resources of a transport network may further include verifying the broken link in which the fault occurs among the plurality of links.

The method of managing resources of a transport network may further include determining whether a registration of the normal link as the reusable resource is to be cancelled.

The method of managing resources of a transport network may further include cancelling the registration of the normal link when a result of the determining indicates cancellation.

The determining may include determining to cancel the registration when the fault of the broken link is eliminated, and the transfer path is once again switched from the preliminary path to the operation path.

The determining may include determining to maintain the registration of the normal link when the fault of the broken link is not eliminated.

The method of managing resources of a transport network may further include receiving a request for setting a traffic transfer path.

The method of managing resources of a transport network may further include setting, in response to the request, the traffic transfer path for the first layer. The method of managing resources of a transport network may further include determining a quality characteristic of traffic of the traffic transfer path.

The setting may include setting the traffic transfer path based on the determined quality characteristic.

The setting may include setting the traffic transfer path based on at least one of a path computation element (PCE) and a constrained shortest path first (CSPF) when a priority of the determined quality characteristic is lower than a priority of a predetermined quality characteristic.

When the priority of the determined quality characteristic is higher than the priority of the predetermined quality characteristic, a link of the second layer to be assigned to the traffic transfer path may be a link not assigned to other paths of the first layer among the links of the second layer.

When the priority of the determined quality characteristic is lower than the priority of the predetermined quality characteristic, a link of the second layer to be assigned to the traffic transfer path may be a link of the reusable resource.

When the setting of the traffic transfer path using the link of the reusable resource is not possible, the link of the second layer to be assigned to the traffic transfer path may include the link of the reusable resource and the link not assigned to other paths of the first layer among the links of the second layer.

The first layer may be a packet transport layer (PTL) of a multiprotocol label switching (MPLS)-transport profile (TP) or an MPLS.

The second layer may be one of an optical transport network (OTN), a wavelength division multiplexing (WDM), a synchronous digital hierarchy (SDH) and a synchronous optical network (SONET).

According to another aspect of the present invention, there is also provided a resource management apparatus including a layer monitoring unit to monitor a fault occurring in a plurality of links of a second layer corresponding to a lower layer of a first layer of a transfer path, a layer resource manager to receive, when a broken link in which the fault occurs is present among the plurality of links, the broken link from the layer monitoring unit, and change a state of the broken link to a fault state, a layer resource database to store the fault state of the broken link, a path database to store a set path in the first layer, and a path manager to search the path database for an operation path of the first layer using the broken link, wherein when the transfer path is switched from the operation path to a preliminary path, the path manager searches the path database for links assigned to the operation path, and wherein the layer resource manager registers a normal link indicating a remaining link of the links, aside from the broken link, as a reusable resource in the layer resource database.

According to still another aspect of the present invention, there is also provided a method of managing resources of a transport network, the method including monitoring a fault occurring in an operation path of a first layer of a transfer path, switching, when the fault is sensed in the operation path, the transfer path from the operation path to a preliminary path of the first layer, and registering a normal link indicating a remaining link of links of a second layer assigned to the operation path, aside from a broken link in which the fault is sensed, to be a reusable resource, wherein the second layer is a lower layer of the first layer.

The method of managing resources of a transport network may further include determining the broken link in which the fault is sensed among the links.

The method of managing resources of a transport network may further include determining whether a registration of the normal link as the reusable resource is to be cancelled.

The method of managing resources of a transport network may further include cancelling the registration of the normal link when a result of the determining indicates cancellation.

The method of managing resources of a transport network may further include receiving a request for setting a traffic transfer path.

The method of managing resources of a transport network may further include setting, in response to the request, the traffic transfer path for the first layer.

The method of managing resources of a transport network may further include determining a quality characteristic of traffic of the traffic transfer path.

The setting may include setting the traffic transfer path based on the determined quality characteristic.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a resource management apparatus for managing resources of a transport network according to an example of embodiment;

FIG. 2 is a diagram illustrating a method of recovering a transfer path when the fault occurs in an operation path according to an example embodiment;

FIG. 3 is a diagram illustrating a method of setting a traffic transfer path using a reusable resource according to an example embodiment;

FIG. 4 is a flowchart illustrating a method of managing resources of a transfer network according to an example embodiment;

FIG. 5 is a flowchart illustrating a method of cancelling a registration of a normal link as a reusable resource according to an example embodiment;

FIG. 6 is a flowchart illustrating a method of setting a traffic transfer path according to an example embodiment;

FIG. 7 is a diagram illustrating an example of using a resource of a second layer when a fault does not occur according to an example embodiment;

FIG. 8 is a diagram illustrating an example of using a resource of a second layer when a fault occurs according to an example embodiment;

FIG. 9 is a diagram illustrating a method of registering a normal link as a reusable resource according to an example embodiment;

FIG. 10 is a diagram illustrating a method of using a reusable resource to set a traffic transfer path according to an example embodiment; and

FIG. 11 is a diagram illustrating a method of managing a path of a transport network according to an example embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The exemplary embodiments may, however, be embodied in many different forms and should not be construed as limited to the embodiments set forth herein. Rather, these embodiments are provided so that this disclosure will be thorough and complete, and all technical spirits falling within the equivalent scope thereof should be interpreted as being included in the scope of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Hereinafter, embodiments of the present invention will be described in detail with reference to the accompanying drawings. When it is determined detailed description related to a known function or configuration they may render the purpose of the present invention unnecessarily ambiguous in describing the present invention, the detailed description will be omitted here.

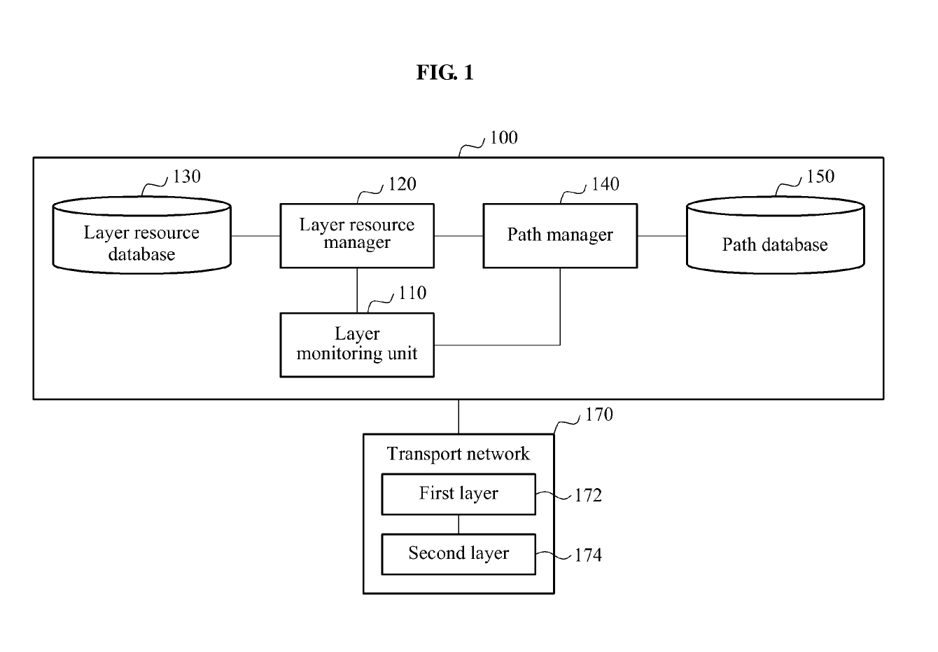

FIG. 1 is a diagram illustrating a configuration of a resource management apparatus 100 for managing resources of a transport network according to an example of embodiment.

The resource management apparatus 100 may include a layer monitoring unit 110, a layer resource manager 120, a layer resource database 130, a path manager 140, and a path database 150. Hereinafter, the resource management apparatus 100 may also be referred to as the apparatus 100.

The apparatus 100 may be connected to a transport network 170. The apparatus 100 may be connected to the transport network 170 to monitor a state of the transport network 170. Also, the apparatus 100 may manage resources of the transport network 170.

The resources of the transport network 170 may include a router, a switch, and a node. Also, the resources of the transport network 170 may include a link between nodes.

The transport network 170 may be an integrated transport network in which a packet transport network and a circuit transport network are integrated.

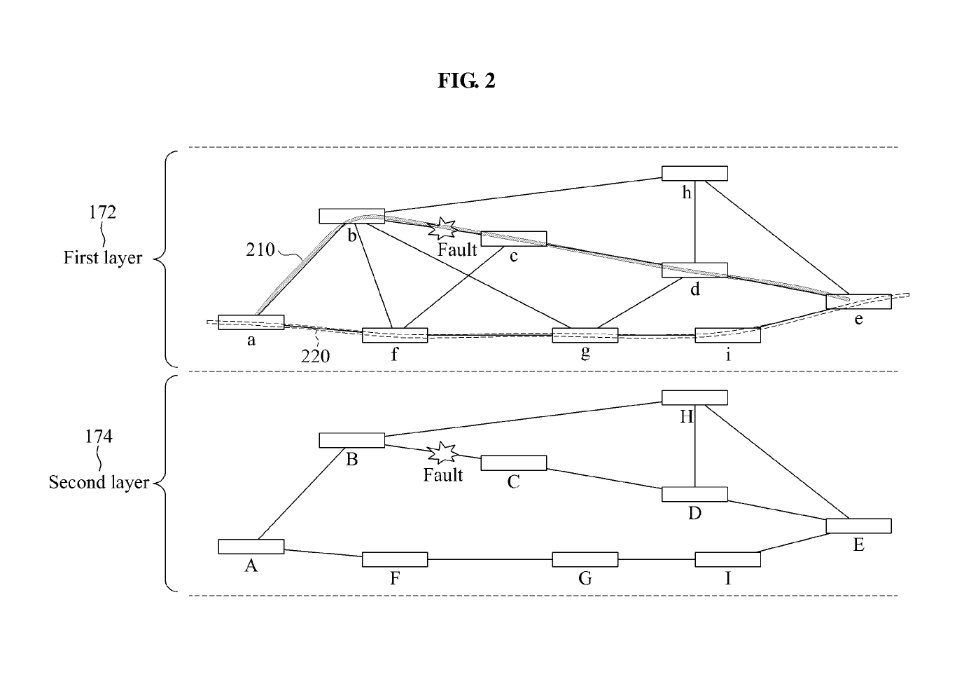

Hereinafter, descriptions about a method in which the apparatus 100 manages a resource of the transport network 170 with reference to FIGS. 2 through 11.

FIG. 2 is a diagram illustrating a method of recovering a transfer path when the fault occurs in an operation path according to an example embodiment.

The transport network 170 may include a plurality of layers. The plurality of layers may include a first layer 172 and a second layer 174.

The second layer 174 may be a lower layer of the first layer 172.

For example, the first layer 172 may be a packet transport layer (PTL) of a multiprotocol label switching (MPLS)-transport profile (TP) or an MPLS.

For example, the second layer 174 may be one of an optical transport network (OTN), a wavelength division multiplexing (WDM), a synchronous digital hierarchy (SDH), and a synchronous optical network (SONET).

The path database 150 may store a path set for the first layer 172. The path set for the first layer 172 may be provided in plural. For example, the path database 150 may store information on an operation path 210 and a preliminary path 220 of the first layer 172.

The operation path 210 and the preliminary path 220 may be a transfer path for traffic transfer.

The operation path 210 may be a label switched path (LSP) for traffic transfer.

The preliminary path 220 may be a path substituted for the operation path 210 to transfer traffic when a fault occurs in the operation path 210 such that the traffic may not be transferred. The preliminary path 220 may be the LSP.

In FIG. 2, elements a through e included in the operation path 210 may transfer traffic using links among A, B, C, D, and E of the second layer 174 as resources.

Elements a through e included in the preliminary path 220 may transfer traffic using links among A, F, G, I, and E of the second layer 174 as resources.

The layer resource database 130 may store states of resources and information on resources of the first layer 172 and the second layer 174. For example, the layer resource database 130 may store states of links and information of links of the second layer 174.

The layer monitoring unit 110 may monitor a state of the transport network 170. For example, the layer monitoring unit 110 may monitor the states of the links of the second layer 174.

For example, when a fault occurs in a link between B and C of the second layer 174, the layer monitoring unit 110 may determine or detect the fault occurring in the link between B and C.

When the fault occurs in the link between B and C, a fault may occur in the operation path 210 using the link between the B and C. When the fault occurs in the operation path 210, the path manager 140 may switch a transfer path from the operation path 210 to the preliminary path 220.

In the second layer 174, a link between A and B, a link between C and D, and a link between D and E may be normal links. Thus, when the transfer path is switched from the operation path 210 to the preliminary path 220, the normal links used for the operation path 210 may be reused.

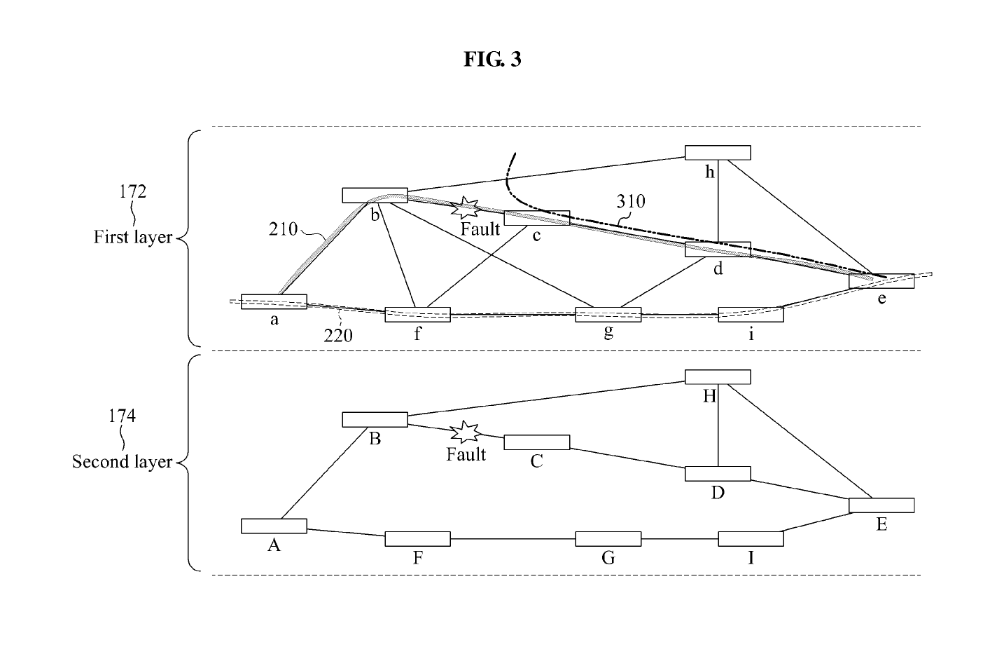

Hereinafter, descriptions about a method of using the normal link as a reusable resource will be provided with reference to FIGS. 3 through 11.

FIG. 3 is a diagram illustrating a method of setting a traffic transfer path using a reusable resource according to an example embodiment.

As described in FIG. 2, when a fault occurs in the link between B and C, the path manager 140 may switch a transfer path from the operation path 210 to the preliminary path 220. When the transfer path is switched from the operation path 210 to the preliminary path 220, a normal link used for the operation path 210 may be assigned for setting a traffic transfer path 310. For example, a link between A and B, a link between C and D, and a link between D and E may be assigned for setting the traffic transfer path 310.

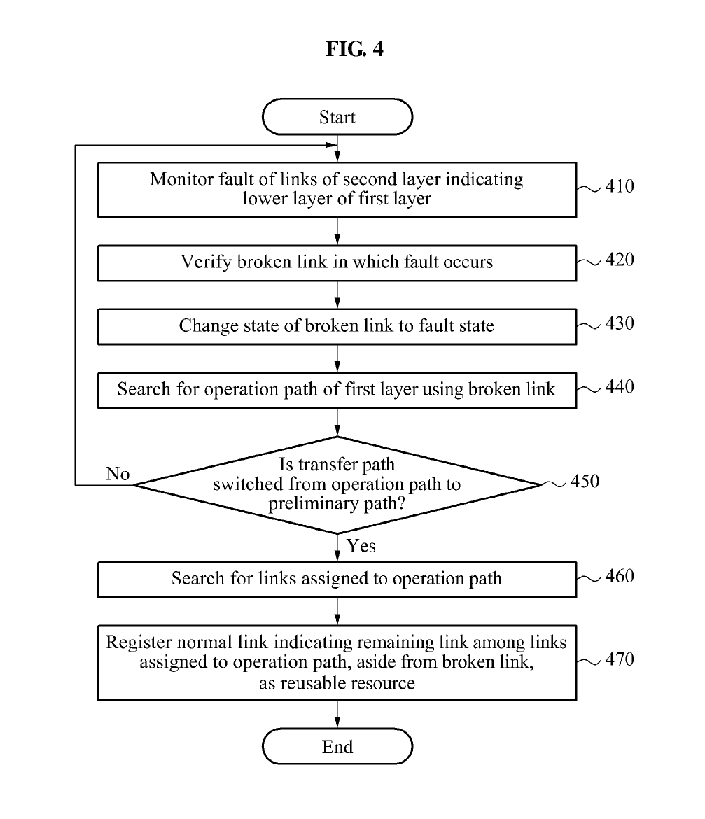

Hereinafter, descriptions about a method of registering the normal link as the reusable resource by priority in order to assign the normal link to the traffic transfer path 310 will be provided with reference to FIG. 4.

Descriptions provided with reference to FIGS. 1 and 2 may be identically applied and thus, repeated descriptions will be omitted for increased clarity and conciseness.

FIG. 4 is a flowchart illustrating a method of managing resources of a transfer network according to an example embodiment.

In operation 410, the layer monitoring unit 110 may determine or detect a fault of the transport network 170 by monitoring the transport network 170. For example, the layer monitoring unit 110 may monitor a fault occurring in a plurality of links of the second layer 174 which is a lower layer of the first layer 172 of a transfer path.

The layer monitoring unit 110 may monitor an occurrence of a fault in the operation path 210 of the first layer 172 by monitoring the fault occurring in the plurality of links of the second layer 174.

In operation 420, when the fault occurs in one of the plurality of links of the second layer 174, the layer monitoring unit 110 may verify a broken link in which the fault occurs among the plurality of links. For example, the broken link may be the link between B and C of FIG. 3.

The layer monitoring unit 110 may transfer information on the broken link to the layer resource manager 120.

In operation 430, when the broken link in which the fault occurs among the plurality of links is present, the layer resource manager 120 may change a state of the broken link to a fault state.

The layer resource database 130 may change the state of the broken link among the plurality of links pre-stored in the layer database 130, to the fault state and store the changed state.

The layer resource manager 120 may transfer the information on the broken link to the path manager 140.

In operation 440, the path manager 140 may search for the operation path 210 of the first layer 172 using the broken link.

In operation 450, the path manager 140 may determine whether the transfer path is switched from the operation path 210 to the preliminary path 220.

An operation in which the transfer path is switched from the operation path 210 to the preliminary path 220 may be performed in parallel when operations 410 through 450 are performed.

For example, the path manager 140 may switch the transfer path from the operation path 210 to the preliminary path 220. Also, the operation in which the transfer path is switched from the operation path 210 to the preliminary path 220 may be performed by a user of the transport network 170.

In an example embodiment, when the preliminary path 220 has not been set, operation 450 may not be performed. Thus, when the transfer path is not recovered, operation 460 may be performed in lieu of operation 450.

In operation 450, when the transfer path is not switched from the operation path 210 to the preliminary path 220, operation 410 may be performed again.

In operation 460, when the transfer path is switched from the operation path 210 to the preliminary path 22, the path manager 140 may search the path database 150 for the operation path 210 using the broken link.

The path manager 140 may search the path database 150 for links assigned to the operation path 210.

The path manager 140 may transfer information on the searched links to the layer resource manager 120.

In operation 470, the layer resource manager 120 may register a normal link as a reusable resource. Here, the normal link may indicate a remaining link among the links assigned to the operation path 210, aside from the broken link, and may be at least one link.

For example, the layer resource manager 120 may register at least one of the link between A and B, the link between C and D, and the link between D and E among the normal links including the link between A and B, the link between B and C, the link between C and D, and the link between D and E, aside from the link between B and C which is the broken link, as described in FIG. 3.

The layer resource manager 120 may store the normal link as the reusable resource in the layer resource database 130.

When the reusable resource is assigned to another path of the first layer 172, the operation path 210 may not be used again. To use the operation path 210, registration as the reusable resource may need to be cancelled such that the reusable resource may be assigned to the operation path 210.

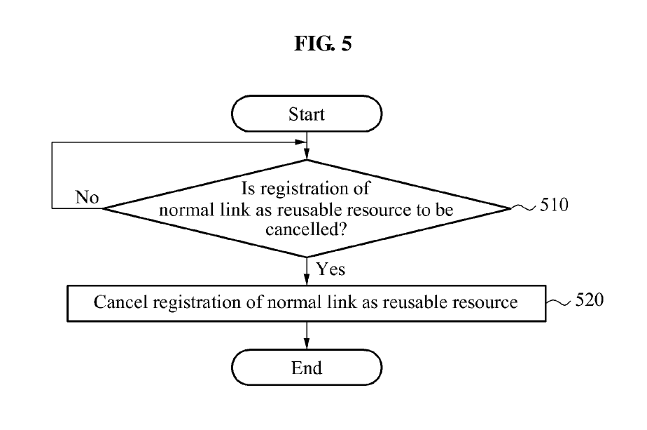

Hereinafter, descriptions about a method of cancelling the reusable resource will be provided with reference to FIG. 5.

Descriptions provided with reference to FIGS. 1 through 3 may be identically applied here and thus, repeated descriptions will be omitted for increased clarity and conciseness.

FIG. 5 is a flowchart illustrating a method of cancelling a registration of a normal link as a reusable resource according to an example embodiment.

The layer monitoring unit 110 may monitor the transport network 170 while the aforementioned operations 410 through 470 are being performed. The layer monitoring unit 110 may determine whether a fault of a broken link is eliminated.

In operation 510, when the fault of the broken link is eliminated, the layer resource manager 120 may determine whether a registration of the normal link as a reusable resource is to be cancelled.

For example, the layer resource manager 120 may determine to perform a cancellation when the fault of the broken link is eliminated or a transfer path is once again switched from the preliminary path 220 to the operation path 210.

As another example, the layer resource manager 120 may determine to maintain the registration when the fault of the broken link is not eliminated.

In operation 520, when the layer resource manager 120 determines to perform a cancellation, the layer resource manager 120 may cancel the registration of the normal link as the reusable resource.

The path manager 140 may search the path database 150, and remove the searched path when a path of the first layer 172 is found, in lieu of operation path 210 using the reusable resource.

Since the normal link is registered as the reusable resource, the normal link may be assigned to another path of the first layer 172 until being cancelled as the reusable resource.

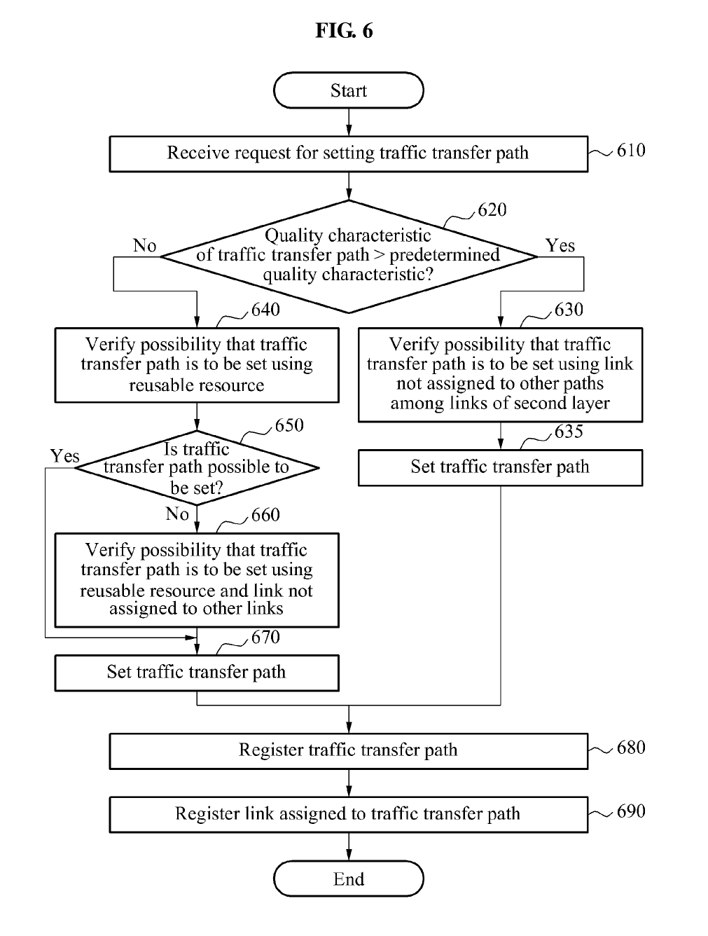

Hereinafter, descriptions about a method of setting another path using the reusable resource will be provided with reference to FIG. 6.

Descriptions provided with reference to FIGS. 1 through 4 may be identically applied here and thus, repeated descriptions will be omitted for increased clarity and conciseness. FIG. 6 is a flowchart illustrating a method of setting a traffic transfer path according to an example embodiment.

Operations 610 through 690 may be performed after the aforementioned operation 470 is performed.

In operation 610, the path manager 140 may receive a request for setting traffic transfer path for traffic transfer. The traffic transfer path may be the traffic transfer path 310 of FIG. 3.

In operation 620, the path manager 140 may determine a quality characteristic of the traffic transfer path.

When a priority of the determined quality characteristic is higher than a priority of a predetermined quality characteristic, operation 630 may be performed.

When the priority of the determined quality characteristic is lower than a priority of the predetermined quality characteristic, operation 640 may be performed.

In operation 630, when the priority of the determined quality characteristic is higher than the priority of the predetermined quality characteristic, the path manager 140 may verify a possibility of the traffic transfer path being set using a link not assigned to other paths of the first layer 172 among links of the second layer 174. The link not assigned to the other path may be a plurality of links.

Operation 635 may be performed when the priority of the determined quality characteristic is higher than the priority of the predetermined quality characteristic. In operation 635, the path manager 140 may set the traffic transfer path for the first layer 172 in response to the request for setting the traffic transfer path.

The path manager 140 may set the traffic transfer path using a link not assigned to other paths. For example, the link to be assigned to the traffic transfer path may be the link not assigned to the other paths of the first layer 172 among the links of the second layer 174.

In operation 640, when the priority of the determined quality characteristic is lower than the priority of the predetermined quality characteristic, the path manager 140 may verify the possibility of the traffic transfer path being set using the reusable resource. The reusable resource may include at least one link.

In operation 650, when it is possible to set the traffic transfer path using the reusable resource, operation 670 may be performed.

In operation 650, when it is not possible to set the traffic transfer path using the reusable resource, operation 660 may be performed.

In operation 660, the path manager 140 may verify the possibility of the traffic transfer path being set using the reusable resource and the link not assigned to the other links.

When it is possible to set the traffic transfer path using the reusable resource and the link not assigned to the other paths, operation 670 may be performed.

Operation 670 may be performed when the priority of the determined quality characteristic is lower than the priority of the predetermined quality characteristic.

In operation 670, the path manager 140 may set the traffic transfer path for the first layer 172 in response to the request for setting the traffic transfer path. In an example embodiment, when it is possible to set the traffic transfer path using the reusable resource, the path manager 140 may set the traffic transfer path using the reusable resource. Thus, the links of the second layer 174 to be assigned to the traffic transfer path may be links of the reusable resource.

For example, the link between C and D and the link between D and E may be assigned to the traffic transfer path 310 with reference to FIG. 3.

In an example embodiment, when it is not possible to set the traffic transfer path using the reusable resource, the path manager 140 may set the traffic transfer path using the link of the reusable resource and the link not assigned to the other paths. Thus, the link to be assigned to the traffic transfer path may include the link of the reusable resource and the link not assigned to the other paths of the first layer 172.

For example, as shown in FIG. 3, at least one link not assigned to the other paths may be a link between B and D and a link between H and E. Thus, the path manager 140 may set the traffic transfer path using at least one of the link between B and D, the link between H and E, the link between A and B, the link between C and D, and the link between D and E.

When the priority of the determined quality characteristic is lower than the priority of the predetermined quality characteristic, the path manager 140 may set the traffic transfer path using at least one of a path computation element (PCE) and a constrained shortest path first (CSPF).

In operation 680, the path manager 140 may register information on the set traffic transfer path in the path database 150.

In operation 690, the layer resource manager 120 may register a link assigned to the traffic transfer path in the layer resource database 130.

Descriptions provided with reference to FIGS. 1 through 5 may be identically applied here and thus, repeated descriptions will be omitted for increased clarity and conciseness.

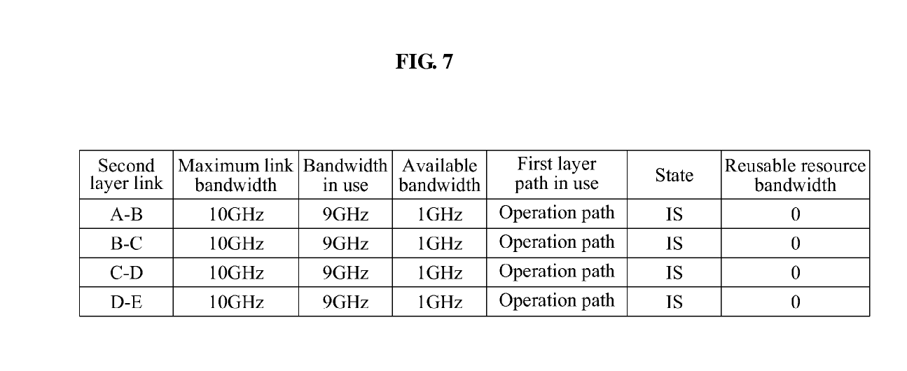

FIG. 7 is a diagram illustrating an example of using a resource of a second layer when a fault does not occur according to an example embodiment.

Referring to FIG. 7, the layer resource database 130 may store information on a plurality of links of the second layer 172 and thus, manage the plurality of links. In FIG. 7, links assigned to the operation path 210 may be shown.

Whether a fault occurs may be indicated as an in-service (IS) or an out of service (OOS) in a link. The IS may indicate a normal state and the OOS may indicate a fault state.

Since states of the link between A and B, the link between B and C, the link between C and D, and the link between D and E described in FIG. 3 are the IS, a fault may not occur in the links. Since the fault is not included in the links, the operation path 210 may be normally operated.

Since the link between A and B, the link between B and C, the link between C and D, and the link between D and E are assigned to the operation path 210 and not registered as a reusable resource, each reusable resource bandwidth may be indicated to be “0”.

Descriptions provided with reference to FIGS. 1 through 6 may be identically applied here and thus, repeated descriptions will be omitted for increased clarity and conciseness.

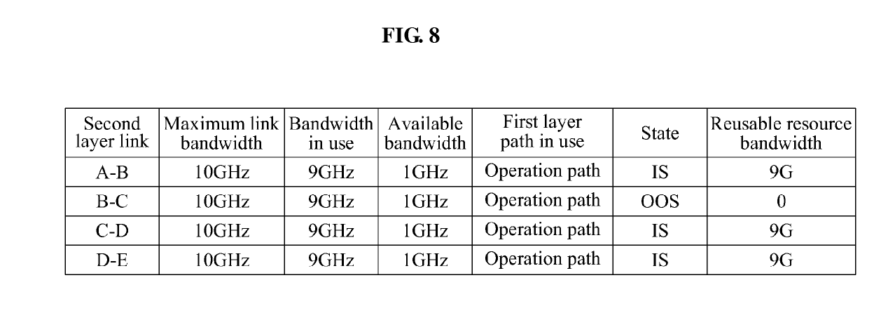

FIG. 8 is a diagram illustrating an example of using a resource of a second layer when a fault occurs according to an example embodiment.

When a fault occurs in the link between B and C of FIG. 3, the layer monitoring unit 110 may detect the fault.

The layer resource manager 120 may change a state of the link between B and C to an OOS.

The layer resource database 130 may store the changed state of the link between B and C.

Due to the fault of the link between B and C, the operation path 210 may not transfer traffic. Thus, a reusable resource bandwidth of the link between A and B, the link between C and D, and the link between D and E may be 9 gigahertz (GHz) Descriptions provided with reference to FIGS. 1 through 7 may be identically applied here and thus, repeated descriptions will be omitted for increased clarity and conciseness.

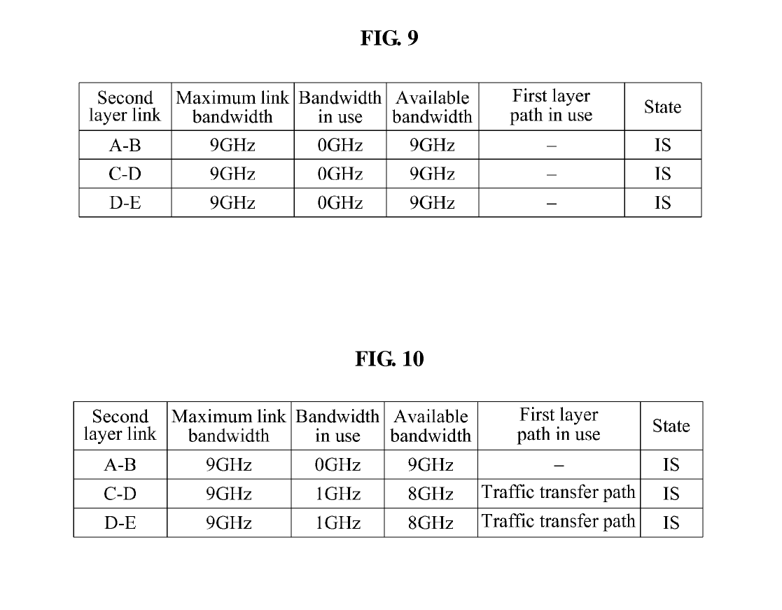

FIG. 9 is a diagram illustrating a method of registering a normal link as a reusable resource according to an example embodiment.

Referring to FIG. 9, information on the normal link registered as the reusable resource and stored in the layer resource database 130 may be indicated according to an example embodiment.

When a fault occurs in the link between B and C of FIG. 3, the link between A and B, the link between C and D, and the link between D and E may be registered as the reusable resource among links assigned to the operation path 210, aside from the link between B and C.

In an example embodiment, a bandwidth used by the operation path 210 may be a maximum link bandwidth of the reusable resource. An available bandwidth may be identical to the maximum link bandwidth.

Since a path using at least one of the link between A and B, the link between C and D, and the link between D and E is not set after the link between A and B, the link between C and D, and the link between D and E are registered as the reusable resource, a path of the first layer 172 being used may not exist.

Descriptions provided with reference to FIGS. 1 through 8 may be identically applied here and thus, repeated descriptions will be omitted for increased clarity and conciseness.

FIG. 10 is a diagram illustrating a method of using a reusable resource to set a traffic transfer path according to an example embodiment.

When the traffic transfer path 310 is set for the first layer 172 using at least one reusable resource, the layer resource manager 120 may change a state of a link between C and D and a state of a link between D and E.

The layer resource database 130 may change and store the state of the link between C and D and the state of the link between D and E.

A link between A and B not assigned to the traffic transfer path 310 may be used to set another path.

Descriptions provided with reference to FIGS. 1 through 9 may be identically applied here and thus, repeated descriptions will be omitted for increased clarity and conciseness.

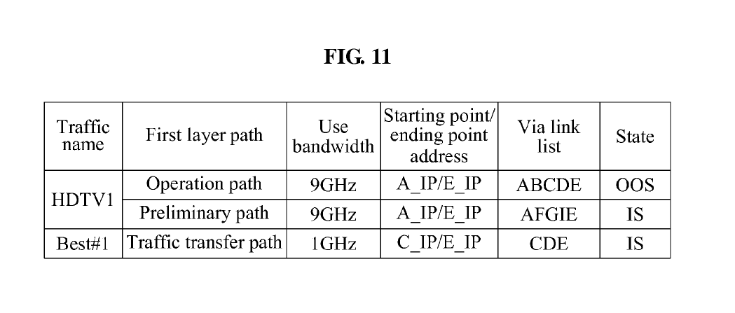

FIG. 11 is a diagram illustrating a method of managing a path of a transport network according to an example embodiment.

When the traffic transfer path 310 is set using a reusable resource, information on paths of the first layer 172 stored in the path database 150 may be indicated with reference to FIG. 11.

A via link may be a link assigned to a corresponding path.

The operation path 210 and the preliminary path 220 may be used for traffic of a high definition television (HDTV) 1 for an HDTV. Since a state of the operation path 210 is an OOS, the traffic of the HDTV 1 may be in a state of being transferred through the preliminary path 220.

Since the state of the operation path 210 is the OOS, the traffic transfer path 310 may be set using a link assigned to the operation path 210. The traffic transfer path 310 may be used for traffic of a best#1.

Descriptions provided with reference to FIGS. 1 through 10 may be identically applied here and thus, repeated descriptions will be omitted for increased clarity and conciseness.

According to an aspect of the present invention, it is possible to provide a method and apparatus for managing resources of a transport network.

According to another aspect of the present invention, it is possible to provide a method and apparatus for using a reusable resource by registering a normal link of a lower layer assigned to a path of an upper layer in which a fault occurs, as the reusable resource.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of managing resources of a transport network, the method comprising:
monitoring a fault occurring in a plurality of links of a second layer corresponding to a lower layer of a first layer of a transfer path;
changing, when a broken link in which the fault occurs is present among the plurality of links, a state of the broken link to a fault state;
searching for an operation path of the first layer using the broken link;
searching, when the transfer path is switched from the operation path to a preliminary path, for links assigned to the operation path; and
registering a normal link indicating a remaining link of the links assigned to the operation path, aside from the broken link, as a reusable resource.

2. The method of claim 1, further comprising:
verifying the broken link in which the fault occurs among the plurality of links.

3. The method of claim 1, further comprising:
determining whether a registration of the normal link as the reusable resource is to be cancelled; and
cancelling the registration of the normal link when a result of the determining indicates cancellation.

4. The method of claim 3, wherein the determining comprises determining to cancel the registration when the fault of the broken link is eliminated, and the transfer path is once again switched from the preliminary path to the operation path.

5. The method of claim 3, wherein the determining comprises determining to maintain the registration of the normal link when the fault of the broken link is not eliminated.

6. The method of claim 1, further comprising:
receiving a request for setting a traffic transfer path; and
setting, in response to the request, the traffic transfer path for the first layer.

7. The method of claim 6, further comprising:
determining a quality characteristic of traffic of the traffic transfer path,
wherein the setting comprises setting the traffic transfer path based on the determined quality characteristic.

8. The method of claim 7, wherein the setting comprises setting the traffic transfer path based on at least one of a path computation element (PCE) and a constrained shortest path first (CSPF) when a priority of the determined quality characteristic is lower than a priority of a predetermined quality characteristic.

9. The method of claim 7, wherein when the priority of the determined quality characteristic is higher than the priority of the predetermined quality characteristic, a link of the second layer to be assigned to the traffic transfer path is a link not assigned to other paths of the first layer among the links of the second layer.

10. The method of claim 7, wherein when the priority of the determined quality characteristic is lower than the priority of the predetermined quality characteristic, a link of the second layer to be assigned to the traffic transfer path is a link of the reusable resource.

11. The method of claim 10, wherein when the setting of the traffic transfer path using the link of the reusable resource is not possible, the link of the second layer to be assigned to the traffic transfer path comprises the link of the reusable resource and the link not assigned to other paths of the first layer among the links of the second layer.

12. The method of claim 1, wherein the first layer is a packet transport layer (PTL) of a multiprotocol label switching (MPLS)-transport profile (TP) or an MPLS.

13. The method of claim 1, wherein the second layer is one of an optical transport network (OTN), a wavelength division multiplexing (WDM), a synchronous digital hierarchy (SDH) and a synchronous optical network (SONET).

14. A resource management apparatus comprising:
a layer monitoring unit to monitor a fault occurring in a plurality of links of a second layer corresponding to a lower layer of a first layer of a transfer path;
a layer resource manager to receive, when a broken link in which the fault occurs is present among the plurality of links, the broken link from the layer monitoring unit, and change a state of the broken link to a fault state;
a layer resource database to store the fault state of the broken link;
a path database to store a set path in the first layer; and
a path manager to search the path database for an operation path of the first layer using the broken link,
wherein when the transfer path is switched from the operation path to a preliminary path, the path manager searches the path database for links assigned to the operation path, and
wherein the layer resource manager registers a normal link indicating a remaining link of the links, aside from the broken link, as a reusable resource in the layer resource database.

15. A method of managing resources of a transport network, the method comprising:
monitoring a fault occurring in an operation path of a first layer of a transfer path;
switching, when the fault is sensed in the operation path, the transfer path from the operation path to a preliminary path of the first layer; and
registering a normal link indicating a remaining link of links of a second layer assigned to the operation path, aside from a broken link in which the fault is sensed, to be a reusable resource,
wherein the second layer is a lower layer of the first layer.

16. The method of claim 15, further comprising:
determining the broken link in which the fault is sensed among the links.

17. The method of claim 15, further comprising:
determining whether a registration of the normal link as the reusable resource is to be cancelled; and
cancelling the registration of the normal link when a result of the determining indicates cancellation.

18. The method of claim 15, further comprising:
receiving a request for setting a traffic transfer path; and
setting, in response to the request, the traffic transfer path for the first layer.

19. The method of claim 18, further comprising:
determining a quality characteristic of traffic of the traffic transfer path,
wherein the setting comprises setting the traffic transfer path based on the determined quality characteristic.
